(19) United States
(12) Patent Application Publication
(10) Pub. No.: US 2019/0041531 A1
(43) Pub. Date: Feb. 7, 2019

(54) VEHICLE NAVIGATION SYSTEMS AND METHODS UTILIZING LOCATION ASSISTANCE FROM A MESH NETWORK

(71) Applicant: Ford Global Technologies, LLC, Dearborn, MI (US)

(72) Inventors: John William SCHMOTZER, Canton, MI (US); Jakob Nikolaus HOELLERBAUER, Canton, MI (US); Praveen Kumar YALAVARTY, Novi, MI (US)

(21) Appl. No.: 16/081,934

(22) PCT Filed: Mar. 3, 2016
(86) PCT No.: PCT/US16/20547

§ 371 Date: Sep. 3, 2018

(51) Int. Cl. G01S 19/46; G08G 1/0969; H04W 4/46; H04W 4/44; G08G 1/0968; G01C 21/26

(52) U.S. Cl. CPC G01S 19/46; G08G 1/0969; G01C 21/26; H04W 4/44; G08G 1/096827; H04W 4/46

(57) ABSTRACT

A mesh network localization system includes at least one base station located on a building roof to receive a GPS signal from a satellite and to transmit a base station location signal. An infrastructure device is located at a ground level to derive its global position based on the base station location signal. A mobile end-device is in communication with the infrastructure device via DSRC, and the infrastructure device transmits a derived global position to the mobile end-device unable to receive a GPS signal.

### TECHNICAL FIELD

The present disclosure relates to a navigation system of a host vehicle communicating with a neighboring vehicle to obtain information indicative of the location of the host vehicle.

### BACKGROUND

A navigation system of a vehicle uses the location of the vehicle in providing navigation functions. The navigation system communicates with, for example, a global navigation satellite system (GNSS) to obtain information indicative of the location of the vehicle. The navigation system uses this information to detect the location of the vehicle and uses the detected vehicle location in providing navigation functions.

Sometimes the navigation system may be unable to communicate with the GNSS to obtain information indicative of the location of the vehicle. Consequently, the navigation system is unable to detect the location of the vehicle. For instance, the navigation system may have a malfunctioned global positioning system (GPS) receiver unable to communicate with the GNSS; or the GPS receiver and the GNSS are unable to communicate with one another due to the vehicle being driven through a tunnel, an area with tall buildings, etc. In the latter cases, communication between the GPS receiver and the GNSS is prevented due to the tunnel or buildings or other obstruction attenuating or obstructing the communication signals.

### SUMMARY

A mesh network localization system includes at least one base station located on a building roof to receive a GPS signal from a satellite and to transmit a base station location signal. An infrastructure device is located at a ground level to derive its global position based on the base station location signal. A mobile end-device is in communication with the infrastructure device via DSRC, and the infrastructure device transmits a derived global position to the mobile end-device unable to receive a GPS signal.

A method of determining vehicle position includes receiving a GPS signal at a plurality of base stations each positioned on a building roof. The method also includes transmitting a base station location signal from each of the plurality of base stations via long-range communication to a static infrastructure device at a ground level. The method further includes deriving a global position of the static infrastructure device based on a base station location signal sent from at least one of the plurality of base stations. The method further includes transmitting a derived global position location of the static infrastructure device via short-range communication to a transceiver at the vehicle, and displaying a vehicle position based on the derived global position of the static infrastructure device when a GPS signal is not received at the vehicle.

A vehicle navigation system includes a GPS module configured to receive a GPS signal and to determine a vehicle position. The vehicle navigation system also includes a DSRC transceiver to communicate with an infrastructure device to receive a derived global position of the infrastructure device when a GPS signal is unavailable. The derived global position of the infrastructure device is based on a location signal sent to the infrastructure device via long-range communication from one or more base stations located on a building roof.

### BRIEF DESCRIPTION OF THE DRAWINGS

FIG. 1 illustrates a block diagram of a navigation system of a vehicle.

FIG. 2 is a schematic view of an urban canyon.

FIG. 3 is a flowchart of a method of determining vehicle position using assistance from a mesh network localization system.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

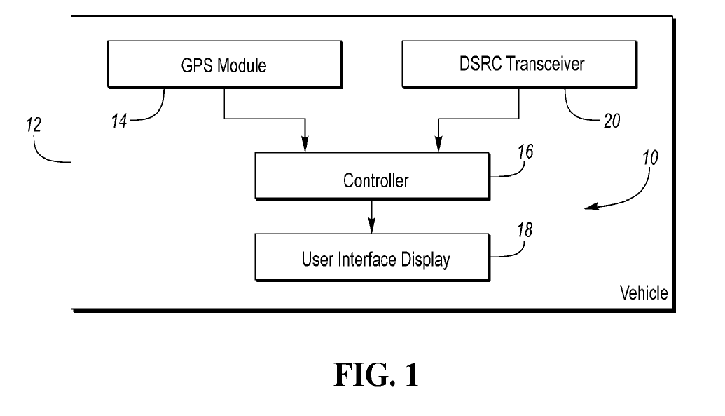

Referring to FIG. 1, a block diagram of a navigation system 10 of a vehicle, such as a vehicle 12, is shown. Navigation system 10 includes a global positioning system (GPS) module 14, a controller 16, and a user interface display 18.

GPS module 14 includes a receiver to obtain information indicative of the global location of vehicle 12 from a remote global navigation satellite system (GNSS) or the like. Controller 16 detects the location of vehicle 12 from the information obtained by GPS module 14 indicative of the location of vehicle 12. Controller 16 generates navigation information based on the location of vehicle 12 and outputs the navigation information to the user interface display 18. The user interface display 18 may include a touch screen or the like to display location information of vehicle 12 on a map for a driver to view. This process is ongoing so that the user interface display 18 is updated as the location of vehicle 12 changes while the vehicle is being driven.

The transceiver 20 is capable of using vehicle-to-vehicle (“V2V”) communications to exchange data with corresponding transceivers of vehicles which are located within the vicinity of vehicle 12. A vehicle is within the vicinity of vehicle 12 when, for example, both vehicles are driving along the same portion of a road. Vehicles within the vicinity of vehicle 12 may be referred to herein as “neighboring vehicles,” “remote vehicles,” or “neighboring (remote) vehicles.” Correspondingly, vehicle 12 may be referred to herein as “the vehicle” or the “host vehicle.”

Transceiver 20 is also capable of using vehicle-to-infrastructure (“V2I”) communications to exchange data with transceivers of static roadside units within the vicinity of vehicle 12. Transceiver 20 may employ Dedicated Short Range Communication (DSRC) technology. Transceiver 20 may also be referred to herein as “DSRC transceiver” 20.

Generally DSRC may be used over roughly a 75 MHz spectrum in the 5.9 GHz band such as that assigned for automotive use by the U.S. Federal Communication Commission. DSRC may be desirable for its low latency, high speed and high tolerance for message loss. The DSRC transceiver 20 at the vehicle is powered by the vehicle's battery system. The transceiver may be in connection with an omni-directional antenna at the vehicle to optimize the wireless communications in a dynamic environment. In one example, a DSRC antenna is located centrally on the roof of the vehicle to have the best available line of sight to neighboring vehicles as well as static infrastructure devices located roadside.

DSRC transceiver 20 of vehicle 12 is able to communicate with other DSRC transceivers of both neighboring vehicles and infrastructure devices within the vicinity over a wireless communications network (e.g., a DSRC communications network). In this way, vehicle 12 is able to exchange data with nearby objects. Further, using DSRC communications, a one or more of these nearby objects within the vicinity of vehicle 12 may communicate with a third object that is within the vicinity of the nearby object but is out of the vicinity of vehicle 12. In this way the nearby object may relay data to the vehicle 12 from sources further away than the immediate vicinity of the vehicle 12 and outside of DSRC range.

In general, the on-vehicle DSRC transceiver is designed for the short-range communication only within a limited area or range of a road by making use of radio wave of a microwave band. In some cases maximum transmission ranges of up to 1000 m are achievable using DSRC but shorter ranges can be more practical to promote greater frequency reuse. Radio communication is transmitted between infrastructure devices installed at various roadside locations and the on-vehicle DSRC apparatus for transferring data. This data transfer may be performed to carry out various services such as a toll collection service, traffic information presentation services and the like. According to aspects of the present disclosure, DSRC is used to augment vehicle navigation.

Several reasons may cause the GPS module 14 to be unable to communicate with the GNSS to obtain information indicative of the location of vehicle 12. For instance, the GPS module 14 may itself malfunction or be hindered by signal blockage or interference. In some cases the receiver is subject to GPS signal blockage due to vehicle 12 being driven through an area such as a tunnel or an area having a number of tall buildings. GPS module 14 may be unable to receive a GPS signal from the GNSS when the tunnel or buildings block the signal transfer between GPS module 14 and the GNSS. Often dense urban areas having many tall buildings may allow inconsistent or fully blocked GPS signal reception. For example an “urban canyon” may be created when a street is flanked by tall buildings on both sides creating a canyon-like environment. These human-built canyons can severely impede GPS reception at the ground level when streets separate dense blocks of tall structures such as skyscrapers.

The GPS module 14 does not provide controller 16 with information indicative of the location of vehicle 12 when the GPS receiver is unable to communicate with the GNSS. Consequently, without being provided with information indicative of the location of vehicle 12 from another source, controller 16 is unable to detect the location of vehicle 12. As a result, controller 16 may be unable to output navigation information based on the location of vehicle 12 to user interface display 18.

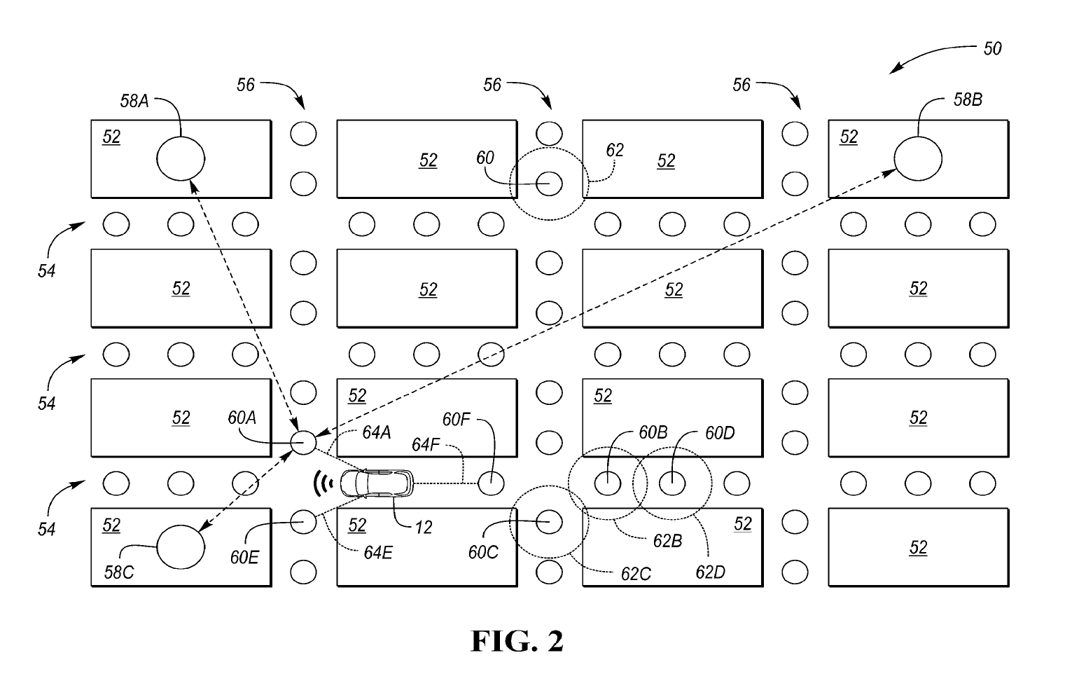

Referring to FIG. 2, with continued reference to FIG. 1, a schematic of a vehicle 12 travelling through an urban canyon environment 50 is depicted. In the example provided, city blocks 52 are separated by a grid of latitudinal streets 54 and longitudinal streets 56. Each of the city blocks 52 houses one or more tall buildings effectively creating a canyon along each street. Base stations 58 are located on a roof of a building on a plurality of city blocks 52. In the example of FIG. 2, three base stations 58A, 58B, and 58C are located at various locations across the urban canyon environment. Each of the base stations 58A, 58B, and 58C includes a GPS transceiver and accurately obtains its own global position based on the receipt of a GPS signal from a satellite. Since each of the base stations is located on the roof of a building reception of the GPS signal is not impeded by structures of the buildings themselves. In alternative embodiments the base stations 58 obtain their own respective locations by other means such as IP communication over a wired or wireless network.

Each of the base stations 58 also includes a transceiver to send long-range signals such as that provided with a LoRa™ network server or gateway. The base stations communicate with other devices at the ground level using public LoRa™ RF communication. Long-range communication between LoRa end-devices and each base station 58 is spread over numerous frequency channels and uses a range of data rates, so a single base station can accommodate a large number of end-devices in in the urban canyon environment. The ground-level devices may communicate via single-hop wireless communication to one or more base stations which in turn may be connected to a central network server via standard IP connections. In some examples, each of the base stations 58 may be configured to operate as both a network server as well as gateway.

The LoRa™ communication protocol offers bi-directionality, security, mobility and accurate localization that are not addressed by some other wireless communication technologies. The LoRa™ communication network allows connection of low-cost, battery-operated sensors over long distances in harsh environments that may otherwise be too challenging or cost prohibitive to connect. For example, LoRa™ transceivers offer penetration capability such that a LoRa™ gateway deployed on a building roof or tower can communicate to ground-level devices as far as 10 miles away or sensors located underground or in basements. Thus the base stations 58 may be spaced apart by large distances to reduce cost and still effectively augment a GPS network. In one example, the base stations 58 are spaced apart by 5 miles or more.

With continued reference to FIG. 2, a plurality of static infrastructure components 60 is located at the ground level. The static infrastructure components 60 may be part of a smart roadway infrastructure to communicate with other devices at the ground level. In one example the static infrastructure components are smart street lamps positioned alongside latitudinal streets 54 and longitudinal streets 56.

Each of the static infrastructure devices 60 is provided with a LoRa™ transceiver to receive signals from the base stations 58. According to an aspect of the present disclosure, the static infrastructure devices receive a signal from one or more base stations 58 indicative of a global position of each sending base station. The base stations 58 are configured to periodically broadcast their own location to infrastructure devices within transmission range. In the example of FIG. 2, static infrastructure device 60A receives a location signal from each of base station 58A, base station 58B, and base station 58C. The receiving static infrastructure device 60A then determines its own position based on multiple location signals. For example the static infrastructure device 60A may triangulate its own position based on the distance from each of the base stations 58A, 58B, and 58C. The communication process itself (e.g., duration of time required to transmit and receive RF signals between the transceiver of a base station and the transceiver of the static infrastructure device) is indicative of the distance between the static infrastructure device and each base station that has broadcast its location within a LoRa™ transmission range.

The static infrastructure devices 60 are configured to be non-specific to a given location. In this way, the infrastructure devices 60 do not need to be preprogrammed with any particular location. An initialization procedure of the static infrastructure devices automatically occurs following a power-up. Each static infrastructure device may listen for base station broadcasts within range to determine its position. Alternatively, the static infrastructure device may send an affirmative request for a location signal to a base station within an available transmission range. In one example, the static infrastructure device uses LoRa™ communication during the initialization procedure to “learn” its own specific location from information received from one or more base stations. Thus the static infrastructure device derives a GPS position without having its own GPS receiver. Additionally, and as discussed above, GPS reception is commonly inconsistent at the ground level. So by receiving location information from rooftop base stations 58, the static infrastructure devices 60 may circumvent a GPS signal reception problem within an urban canyon for example. Once initialization is completed, each static infrastructure device 60 stores its derived global position for subsequent transmission using DSRC to nearby end-devices.

Each of the static infrastructure devices 60 are provided with a DSRC transceiver capable of transmitting a short-range signal to nearby end-devices. For example, each static infrastructure device 60 communicates with navigation system 10 of one or more host vehicles 12 to provide information indicative of the location of host vehicle 12. In particular, transceiver 20 of host vehicle 12 communicates with a transceiver of one or more static infrastructure devices 60 to obtain the location of the sending infrastructure device. As host vehicle 12 is within the vicinity of a static infrastructure device, the location of the nearby static infrastructure device is generally indicative of the location of host vehicle 12. Further, the communication process itself (e.g., duration of time consumed for transmitting and receiving RF signals between transceiver 20 of host vehicle 12 and the infrastructure device) is indicative of the distance between the host vehicle and the infrastructure device. The detected distance between host vehicle 12 and infrastructure device in conjunction with the location of the infrastructure device is further indicative of the location of host vehicle 12.

Each static infrastructure device 60 includes a DSRC transmission range 62 emanating from the device. The static infrastructure devices 60 may be located having a spatial relationship relative to one another such that the DSRC range of a first infrastructure device overlaps with DSRC ranges of at least one adjacent static infrastructure device. In this way, potential gaps in signal coverage at the ground level can be minimized or eliminated. With continued reference to FIG. 2, example ranges of certain infrastructure devices are depicted. Although only a handful of select infrastructure devices and DSRC ranges are annotated by way of example, it is contemplated that each of the infrastructure devices 60 includes a DSRC transceiver having a corresponding transmission range 62 about the device. In the example of FIG. 2, a first static infrastructure device 60B includes a transmission range 62B. In the example provided the transmission range 62B overlaps with both of a transmission range 62C of infrastructure device 60C, as well as transmission range 62D of infrastructure device 60D. Therefore a continuous DSRC transmission zone may be provided to continuously communicate with the host vehicle 12 as it travels along a road passing each of the infrastructure devices 60B, 60C, and 60D.

The overlap of the transmission ranges 62 of the static infrastructure devices 60 also allows the infrastructure devices to communicate with one another. If for example, a particular infrastructure device or set of devices is out of range from the base stations 58, the location information can be relayed through a series of infrastructure devices 60 such that the devices which are out of range from a base station may still receive location information in order to derive their own respective global position locations. In one example, when vehicle 12 is in a tunnel, host vehicle 12 may not be able to obtain the location information from a directly-received GPS signal. However, by providing a series of static infrastructure devices having overlapping DSRC transmission ranges throughout the tunnel, the vehicle 12 may still be able to display accurate location information based on derived global position locations of nearby static infrastructure devices as the vehicle traverses the tunnel. The derived global position of one static infrastructure device may then be based on a secondary derived global position transmitted from an adjacent static infrastructure device. Thus location data can be obtained at the vehicle throughout the tunnel where neither the vehicle nor the static infrastructure devices receives location information directly from a long-range remote source.

According to an aspect of the present disclosure, communication network may have a number of different operation protocols to communicate location information to an end-device such as vehicle 12. In a first example the end-device may send an affirmative DSRC request to nearby static infrastructure devices for information where the response includes derived GPS location information. In a second example, the static infrastructure devices repeatedly broadcast their respective derived GPS locations via DSRC once the initialization is completed and they have learned their current location. Further, some combination of the two communication protocols may likewise be used to provide location information to end-devices when a GPS signal is unavailable at the ground level.

Vehicle 12 may communicate with one or more infrastructure devices 60 via a DSRC network path 64. By way of example, FIG. 2 depicts vehicle 12 is shown as communicating with each of static infrastructure devices 60A, 60E and 60F. These communications are performed by transmitting data over DSRC network paths 64A, 64E, and 64F, respectively. Each static infrastructure device provides a data transmission including information about its derived global position location.

Controller 16 detects the location of vehicle 12 based on the obtained location of a nearby static infrastructure device 60 and the detected distance between vehicle 12 and the infrastructure device 60. For instance, in the example in which DSRC transceiver 20 obtains the derived locations of each of static infrastructure device 60A, 60E and 60F and detects distances between vehicle 12 and each of static infrastructure device 60A, 60E and 60F, controller 16 uses the obtained locations and the detected distances in conjunction with one another to further improve the accuracy of the displayed location of host vehicle 12. The controller 16 may triangulate a global position of the vehicle based on a plurality of derived global position locations.

Controller 16 uses the detected location of host vehicle 12 in providing navigation information to the driver at user interface display 18. Alternately, controller 16 may use the detected general location of vehicle 12 in providing navigation information at user interface display 18 when the distance between vehicle 12 and a nearby static infrastructure device 60 is relatively small.

The base stations 58 combined with static infrastructure devices 60 which communicate with various end-devices at the ground level creates a mesh network localization system that is capable of augmenting GPS navigation in an urban canyon environment where GPS reception is less than reliable.

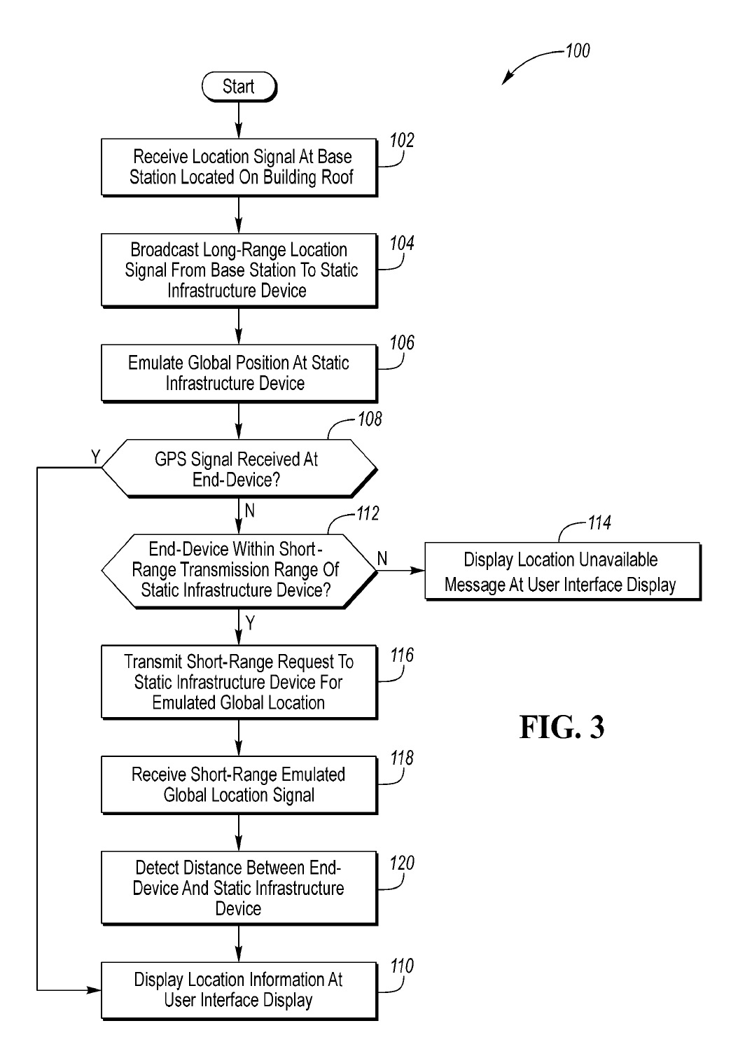

FIG. 3 is a flowchart of a method 100 of determining vehicle position using assistance from a mesh network localization system. At step 102 location information is received at a base station positioned on a building roof. The location information indicated the global position of the base station itself. As discussed above, this location information may be provided via a GPS signal from a global navigation satellite. Alternatively the base station may be hard wired and receive data via an IP network connection or the like.

At step 104 the base station transmits a location signal via long-range communication to a plurality of devices at the ground level. In one example the base station broadcasts its location using public LoRa™ RF communication to a plurality of static infrastructure devices along a street. In a more specific example, the LoRa™ signal is received by at least one intelligent street lamp to operate as a static infrastructure device to relay global location information to passing end-devices unable to receive GPS signals.

At step 106, the static infrastructure device uses location information to derive a global position location. In one example, the static infrastructure device uses a location signal received from each of at least three base stations each located on a different building roof in order to triangulate its own position. In further examples, the static infrastructure device derives a global position location based a short-range signal received from a different infrastructure device.

If at step 108 a mobile end-device controller receives a GPS signal directly, the controller causes at step 110 a display of the location information based on the GPS signal at a user interface display. In one example, the mobile end-device is a vehicle having a GPS transceiver and a navigation display.

If at step 108 no GPS signal is received at the end-device, a controller detects at step 112 whether a static infrastructure device is nearby and within transmission range of a sort-range communication. In one example the short-range communication performed using a DSRC protocol.

If the end-device is not within a transmission range of a nearby static infrastructure device at step 112, a controller may cause a user interface display to provide a “location unavailable” message to a user at step 114.

If at step 112 the controller detects a static infrastructure device within a short-range communication range, the controller may transmit at step 116 a short-range request to the static infrastructure device to obtain derived global location data from the infrastructure device.

At step 118 the controller receives the derived global location signal transmitted from the static infrastructure device. While an affirmative request is described at step 116, in some embodiments the static infrastructure device repeatedly broadcasts its derived global position, and the end-device controller passively receives the derived location once the infrastructure device is detected. In other words, some examples may omit the affirmative request by the end-device which is shown at step 116.

At step 120 the controller may detect a distance between the end-device and the static infrastructure device. In one example, the distance is based on aspects of the short-range signal indicative of the derived global location.

At step 110 the controller causes the display of location information at a user interface display to inform a user of the location of the end-device. In some examples, the displayed location information is based on the derived location of the static infrastructure device and a distance between the end-device and the static infrastructure device. In other examples the displayed location information is based on a distance between the end-device and each of a plurality of different static infrastructure devices.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A mesh network localization system comprising:
a base station located on a building to receive a GPS signal from a satellite and to transmit a base station location signal; and
an infrastructure device located at ground level to derive global position based on the base station location signal and to transmit a derived global position to a mobile end-device in communication with the infrastructure device via DSRC and unable to receive a GPS signal.

2. The mesh network localization system of claim 1, wherein the infrastructure device derives a global position based on long-range signals transmitted from three base stations each located on a different building.

3. The mesh network localization system of claim 1, wherein the infrastructure device includes a DSRC transmission range that overlaps with a transmission range of at least one adjacent infrastructure device.

4. The mesh network localization system of claim 1, wherein the infrastructure device is a street lamp having a DSRC transceiver.

5. The mesh network localization system of claim 1, wherein the infrastructure device is initialized upon power-up by requesting at least one of the base station location signal from a base station and a derived global position of an adjacent infrastructure device.

6. The mesh network localization system of claim 1, wherein the mobile end-device is a vehicle including a user interface display, and the end-device displays a vehicle location based on the derived global position of the infrastructure device and a distance between the vehicle and the infrastructure device.

7. The mesh network localization system of claim 1, wherein the mobile end-device requests the derived global position of the infrastructure device via DSRC when the GPS signal is unavailable.

8. A method of determining vehicle position comprising:
receiving a GPS signal at a plurality of base stations each positioned on a building roof;
transmitting a base station location signal from each of the plurality of base stations via long-range communication to a static infrastructure device at a ground level;
deriving a global position of the static infrastructure device based on a base station location signal sent from at least one of the plurality of base stations;
transmitting a derived global position location of the static infrastructure device via short-range communication to a transceiver at the vehicle; and
displaying a vehicle position based on the derived global position of the static infrastructure device when a GPS signal is not received at the vehicle.

9. The method of determining vehicle position of claim 8, wherein the derived global position is based on a base station location signal transmitted from each of at least three base stations.

10. The method of determining vehicle position of claim 8, wherein the derived global position is further based on a secondary global position transmitted from an adjacent static infrastructure device.

11. The method of determining vehicle position of claim 8 further comprising initializing the static infrastructure device upon a power-up by requesting at least one of a base station location signal from at least one of a base station and a secondary global position of an adjacent static infrastructure device.

12. The method of determining vehicle position of claim 8, wherein the vehicle position is based on the derived global position of the static infrastructure device and a distance between the vehicle and the static infrastructure device.

13. The method of determining vehicle position of claim 8, wherein the vehicle position is based on a distance between the vehicle and each of a plurality of static infrastructure devices.

14. A vehicle navigation system comprising:
a GPS module configured to receive a GPS signal and to determine a vehicle position; and
a DSRC transceiver to communicate with an infrastructure device to receive a derived global position of the infrastructure device when a GPS signal is unavailable, the derived global position being based on a location signal sent to the infrastructure device via long-range communication from one or more base stations located on a building roof.

15. The vehicle navigation system of claim 14, wherein the infrastructure device is an intelligent street lamp that derives a global position during an initialization procedure based on a location signal transmitted from each of at least three base stations.

16. The vehicle navigation system of claim 14 further comprising a user interface display configured to display a global position location of the vehicle based on an available GPS signal, and to display a global position location of the vehicle based on the derived global position when a GPS signal is unavailable.

17. The vehicle navigation system of claim 14 wherein the DSRC transceiver receives a derived global position for each of a plurality of infrastructure devices and triangulates the vehicle position based on a plurality of derived global position.

18. The vehicle navigation system of claim 14 further comprising a user interface configured to display the vehicle position based on the derived global position of the infrastructure device and a distance between the vehicle and the infrastructure device.

19. The vehicle navigation system of claim 14 further comprising a user interface configured to display the vehicle position based on a distance between the vehicle and each of a plurality of different infrastructure devices.
